(19) United States
(12) Patent Application Publication
(10) Pub. No.: US 2004/0013772 A1
(43) Pub. Date: Jan. 22, 2004

(54) Edible drinking straw fortified with nutritional supplements

(76) Inventors: Sanford B. Weiss, Los Angeles, CA (US); Andrew I. Wolf, Los Angeles, CA (US)

Correspondence Address: Matthew A. Newboles, STETINA BRUNDA GARRED & BRUCKER, SUITE 250, 75 ENTERPRISE, ALISO VIEJO, CA, 92656, US

(21) Appl. No.: 10/196,883

(22) Filed: Jul. 17, 2002

(51) Int. Cl. A23G 1/00

(52) U.S. Cl. 426/104

(57) ABSTRACT

An edible, nutrient-rich drinking straw for use in consuming beverages. Preferably, the drinking straw is formed from one or more compressed fruit powders, natural flavor, natural color and humectant that is extruded to assume the drinking straw shape. Thereafter a sealing coating, such as wax, is applied to the straw. The straw of the present invention may be formulated to have a desired rate at which it dissolves into a beverage, and may further be formed to have any of a variety of alternative configurations, such as other types of utensils for consuming food and beverages.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

Drinking straws are well-known and extensively utilized to consume beverages. Generally, drinking straws comprise an elongate cylindrical sleeve defining a lumen therein through which a liquid beverage can be consumed. Essentially, an opposed end of the straw is submerged within the beverage to be consumed, the latter of which is drawn upwardly there through via a vacuum force created by the user's mouth on the other opposed end of the straw.

The vast majority of drinking straws currently in use are manufactured from plastic. In this respect, most straws are typically manufactured through an extrusion process whereby straws are formed to have a desired length, cut, and thereafter packaged. Because the same are made from plastic, however, the same pose significant problems. More specifically, by virtue of being formed from plastic, the straws are not biodegradable and, because the same are typically disposed of following use, create a substantial source of pollution. Such feature is particularly problematic given the fact that straws are typically utilized for short duration (i.e., the consumption of one beverage) and are ill-suited for reuse.

Along these lines, perhaps the most wide spread use of drinking straws is in relation to the consumption of soft drinks sold through convenience stores and fast food restaurants. While such establishments offer tremendous convenience, often times the food products offered thereby are substantially deficient in essential nutrients. Indeed, most soft drinks comprise nothing more than carbonated beverages having a high sugar content, which at best contains only a slight fraction of natural fruit juice.

As such, it is apparent that the needs in the art, although unrelated, are at least two fold. More specifically, problems have been and continue to exist with respect to the use of conventional drinking straws as well as the generally nutrient-void beverages typically consumed therewith. In light of such shortcomings, it is clearly apparent that there is a substantial need for a nutritional food product or supplement, preferably in the form of a conventional drinking straw, that is capable of functioning as a nutritional food product imparting essential nutrients while simultaneously functioning as a conventional straw.

Moreover, there is a need for such a straw that can actually be utilized as a vehicle to enhance the flavor of a given beverage while at the same time imparting essential nutrients to be consumed. There is likewise a need for such a straw that can be alternatively molded into a variety of utensils for consuming food that themselves can be consumed, which thus pose no threat of pollution and the like. Such item would further preferably be of low expense, may be formulated to have a desired flavor, and capable of assuming a variety of configurations to make the same more appealing to consumers, and especially to children.

### BRIEF SUMMARY OF THE INVENTION

The present invention specifically addresses and alleviates the above-identified deficiencies in the art. In this regard, the present invention is directed to an edible drinking straw for use in consuming beverages that can thereafter be consumed. According to a preferred embodiment, the straw comprises the combination of a fruit powder base mixed with a humectant, natural color, natural flavor, and optionally, one of more nutritional supplements, such as vitamins, minerals, herbal extracts, and the like that are extruded and cut to form the desired straw shape. The extruded straw structure is thereafter coated with an edible water repellent coating, such as carnauba wax, a shellac or other coatings typically used in the candy industry, and packaged in a moisture proof barrier.

The formulation of the straw can be selectively manipulated to enable the straw to possess one or more desired qualities. For example, a higher concentration of the humectant may be added to impart greater flexibility. Additionally, the concentrate can be extruded to have any of a variety of shapes and need not be limited in its application as a drinking straw. For example, the straw of the present invention can be formed to serve as a combination spoon and drinking straw or otherwise formed as any of a variety of conventional eating utensils, such as forks, knives, spoons, chop sticks, and the like. Moreover, in another embodiment, the straw may be configured as a whistle or flute-type musical instrument to thus make the same more appealing, especially to children.

In use, the drinking straw of the present invention, or any other form the same may take, may be utilized in a conventional manner (i.e., as per regular drinking straws and utensils). In contrast to such conventional drinking straws and utensils, however, those of the present invention can be consumed either during or after the consumption of the beverage or food product utilized therewith. Along these lines, it is contemplated that the edible drinking straw and variations thereof according to the present invention can be utilized as a flavor enhancer to impart a desired taste to a food product or complement a particular meal. To that end, it is contemplated that the edible drinking straw and variations thereof made according to the present invention can be formulated to have a desired melt rate at which the same dissolves or otherwise releases one or more flavor enhancing agents to a given food or beverage product. Similarly, the present invention may be utilized as a vehicle to impart desired nutrients and other nutritional supplements to a food item, and in particular a food item typically devoid of any type of nutritional value, such as soft drinks and the like.

Accordingly, it is an object of the present invention to provide an edible drinking straw and other edible eating utensils that, in addition to facilitating the ability of an individual to consume a particular beverage and/or food product, can themselves be consumed.

Another object of the present invention is to provide an edible drinking straw and other edible eating utensils that are capable of imparting a desired flavor to the beverage and/or food product consumed thereby.

Another object of the present invention is to provide an edible drinking straw and other edible eating utensils that are capable of serving as a nutritional food source and can be fortified with nutritional supplements, such as vitamins, minerals, herbal extracts, and the like, to promote health and well being, and especially provide nutrition when used in combination with foods typically void of nutritional value.

Another object of the present invention is to provide an edible drinking straw and other edible eating utensils that are made from all natural ingredients and do not include any type of preservatives or artificial additives.

Another object of the present invention is to provide an edible drinking straw and other edible eating utensils that can be formed to have any of a variety of desired properties, including taking the form of a musical instrument, and can be made especially appealing for consumption by children.

Still further objects of the present invention is to provide an edible drinking straw and other edible eating utensils that can be readily and easily manufactured utilizing conventional manufacturing techniques, utilizes commercially available materials, can be manufactured at an extremely low cost, and can be readily substituted for existing drinking straws and utensils currently in use, particularly with respect to disposable drinking straws and utensils provided in most cafeterias, most fast food restaurants, and the like.

### BRIEF DESCRIPTION OF THE DRAWINGS

These as well as other features of the present invention will become more apparent upon reference to the drawings wherein:

FIG. 1 is a perspective view of a glass containing a beverage and edible drinking straw therein, the drinking straw being constructed in accordance to a preferred embodiment of the present invention.

FIG. 2 is a perspective view of the edible drinking straw the present invention as constructed in accordance with a second preferred embodiment.

FIG. 3 is a side view depicting an extrusion process utilized in formulating the edible drinking straw the present invention.

FIG. 4 is a cross section taken along line 4-4 of FIG. 3.

FIG. 5 is an alternative cross sectional view of the edible drinking straw the present invention.

FIG. 6 is a flow chart depicting the steps performing the edible drinking straw of the present invention.

### DETAILED DESCRIPTION OF THE INVENTION

The detailed description as set forth below in connection with the appended drawings is intended as a description of the presently preferred embodiments of the invention, and is not intended to represent the only form in which the present invention may be constructed or utilized. The description sets forth the functions and sequences of steps for constructing and operating the invention in connection with the illustrated embodiments. It is understood, however, that the same or equivalent functions and sequences may be accomplished by different embodiments and that they are also intended to be encompassed within the scope of this invention.

The present invention is directed to an edible drinking straw plus other types of edible eating utensils that can be readily consumed during or after the consumption of a beverage or food product. Advantageously, the drinking straw and utensils of the present invention are formed from all natural ingredients, and can function as a nutritional food product capable of delivering any of a variety of nutritional supplements, such as vitamins, minerals, herbal extracts, or any other type of supplement known in the art. Moreover, the edible drinking straw and utensils of the present invention can be utilized to impart a desired flavor to a particular beverage or food product, especially with respect to fruit flavors and the like as discussed more fully below. Still further, the edible drinking straw and utensils of the present invention have the advantage of not only supplementing the nutritional value of a food or beverage consumed thereby, in particular fast food items and soft drinks, but also, do not pose any type of wasteful byproduct which must necessarily be discarded, as are most drinking straws and utensils formed from plastic materials that are often discarded following a single use.

Preferably, the edible drinking straw 10 of the present invention is formed from an extruded mixture as shown in FIG. 3 comprising the combination of one or more fruit powders, a humectant, natural flavor and natural color. In this respect, the straw will comprise at least 80.0% by weight of fruit powder, and more preferably, between approximately 85.0-95.0% by weight of fruit powder. In a most highly refined embodiment, the edible straw will be formed from approximately 91.0% fruit powder by weight.

Along these lines, it will be readily appreciated by those skilled in the art that such fruit powder may take any of a variety of a conventional fruit powders, such as banana, apple, pear and the like, all of which will preferably have less than 3.0% moisture content. Among suppliers of such fruit powders for use in the present invention include TreeTop, Inc. of Selah, Wash.

It will be readily appreciated by those skilled in the art that in order to cause the straw to possess a particular type of flavor, such powders may be used individually or in combination to thus obtain a balance in the concentrations of sugars and starches present in the respective powders. For example, it should be understood that a blend of apple and pear powders may be desired to impart a highly sweetened fruit taste.

With respect to the humectant, the same may comprise any of a variety of edible humectants known in the art. One preferred humectant includes glycerine, which is preferably present anywhere from 0.5% to 6.0% by weight. According to a preferred embodiment, glycerine is present in an amount of approximately 3.0% by weight. As will further be appreciated by those skilled in the art, by virtue of the properties of the humectant to impart a gel like consistency, the amount of the humectant may be varied within such range in order to impart the desired degree of flexibility or rigidity, consistent with most plastic drinking straws currently in use.

With respect to the natural color and flavor components, the same may take any of a variety of well-known flavors and colors in the art. For example, the natural color component can comprise any type of natural color food additive such as sugar beet extract, carrot extract, grape skin extract, chlorophyl extract, and the like. The same may likewise be procured from any of a variety of sources, such as D. D. Williamson of Louisville, Ky. Similarly, the natural flavor component may take any of a variety known in the art and may be procured from any of a variety of sources, such as Flavor Producers, Inc., of Los Angeles, Calif. With respect to such components, the natural color will be present in an amount between approximately 0.25% to 3.0% by weight, with approximately 1.0% being most preferred, and the natural flavor will be present in an amount anywhere from 1.0% to 10.0% by weight, with approximately 5.0% being preferred.

In an optional, yet important aspect of the present invention, there may further be added one or more nutritional supplement components to enhance the nutritional value of the edible straws and utensil products disclosed herein. In this respect, it is contemplated that any of a variety of nutritional supplements, including but not limited to, vitamins, minerals, herbal extracts, amino acids or other types of dietary supplements, such as creatine and other types of functional and/or medicinal foods can be included within the ingredients utilized in the edible drinking straws and utensils of the present invention.

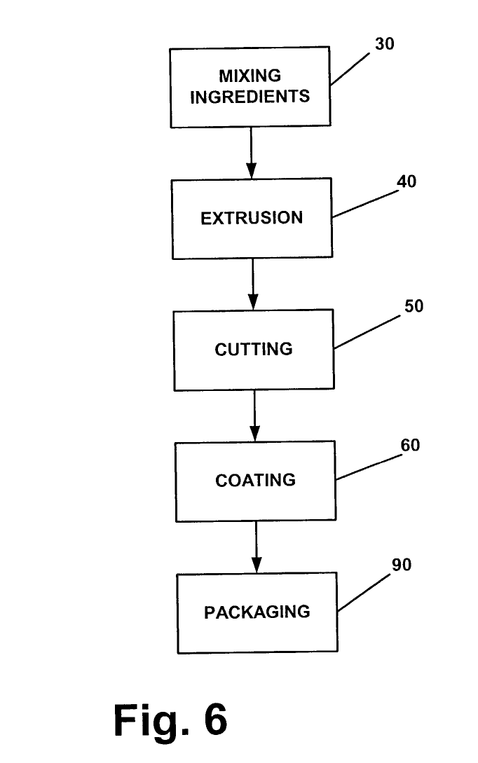

Refering now to FIG. 6, there is depicted a flow chart illustrating the steps for forming the edible drinking straw of the present invention. As illustrated, the process comprises the initial step 30 of mixing the ingredients together. Due to the excitable nature of the ingredients utilized to form the drinking straw and utensils of the present invention, the same must necessarily mixed in a low humidity environment, which is preferably an environment of 5.0% humidity or less, with 3.0% humidity or less being most preferred. The ingredients may be mixed via any of a variety of conventional mixing methods shown in the art.

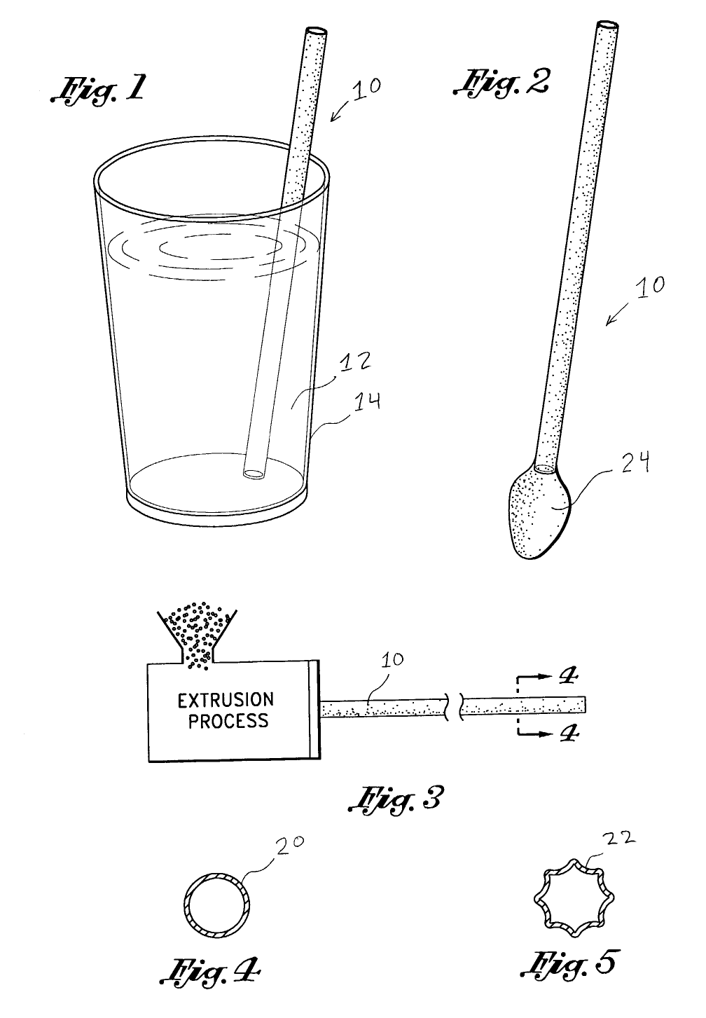

Once a homogenous mixture has been attained, such mixture is then extruded 40 to form the desired drinking straw configuration. Preferably, a twin extruder is utilized that has the capability of compacting the powdered ingredients mixed together to thus enable the same to bind more securely to assume the drinking straw shape, as depicted in FIG. 1. As per conventional food extrusion processes, the straw diameter may be adjusted by changing the extruder forming die and as such, can advantageously allow for the creation of various internal and external diameters, such as the circular cross-section 20 depicted in FIG. 4 or fluted cross-section 22 depicted in FIG. 5,as may be necessary or desired for certain applications.

Following extrusion, the fruit mixture is cut 50 to a desired length utilizing a conventional cutter. In one alternative cutting process, the extruded fruit mixture is cut such that a smaller cut is formed upon one of the opposing ends of the extruded straw with the tubular fruit mixture being flattened at such cut end via a roller to thus form a flattened end that can be utilized as a spoon 24, as shown in FIG. 2. According to such variation, the drinking straw is capable of functioning as both a drinking straw and as a spoon, as per conventional designs utilized to consume ice cream and crushed ice-based beverages.

Following the cutting step, a coating 60 is then formed about the drinking straw structure. In this respect, the straw is coated with an edible water repellant coating, which preferably comprises carnauba wax, a shellac, or other type of coating typically used in the candy industry. As will be appreciated, for any coating utilized, the same should possess superior water repellant properties in order to prevent the straw from rapidly re-hydrating to the extent the same is subjected to levels of higher humidity (i.e., higher than the 5.0% humidity under which the present manufacturing process is conducted). To form such coating, any of a variety of conventional techniques may be utilized, including spraying or dipping techniques known in the art.

Once the coating has been formed upon the straw, the straw may then be packaged 70. To that end, the product is packaged in any of a variety of conventional packaging materials having a good moisture barrier to prevent the product from rehydrating. In this respect, it is believed that the straws of the present invention should be hermetically sealed using a proper moisture barrier film, which may be selected from any of a wide variety of films commercially available.

In an alternative method for making the drinking straws of the present invention, although not necessarily preferred, the materials are mixed as per step 30 discussed above, followed by a low pressure extrusion 40 of such mixture to form the straw-like structure, followed by the cutting step 50. The cut extruded material is then dried in order to thoroughly dehydrate the straw product. Following the drying step, the coating and packaging steps are performed as discussed above. Such alternative methodology may be useful in some applications where it is desired to form a softer straw or a straw having a higher moisture content. To enable the straw to retain some degree of rigidity, however, as will be necessary to function as a straw, the drying step is necessary to ensure sufficient dehydration.

Generally, to the extent the drinking straws of the present invention are formed according to the foregoing methods and including the proportionate amount of ingredients, the same can be used to drink liquids 12 from beverage containers 14 and/or eat solids, as per conventional straws and the like as depicted in FIG. 1, and should last for at least 30 minutes without degrading to the point to where the same can no longer be utilized. It will be recognized, however, that the melt rate may be adjusted based upon the degree of compaction of ingredients made during the extrusion process as well as the thickness of the coating applied to the straw product prior to packaging. Other factors effecting the structural rigidity of the straw can be manipulated via the extrusion and cutting process. More specifically, a straw having a thicker wall portion and shorter length will be structurally more rigid than a straw having a larger inner diameter and longer length. Such adjustments can readily be made by one skilled in the art to suit a particular application.

In addition to being utilized as a drinking straw 10 or a drinking straw having a spoon 24 formed at an end thereof, the compositions and methods of the present invention can further be utilized to manufacture a wide variety of eating utensils. In this respect, it will be understood and appreciated that the fruit powder-based composition can be extruded or otherwise molded to assume fork, knife and/or spoon configurations. It is further contemplated that chopsticks can be formed utilizing the compositions and methods of the present invention.

In this respect, it is contemplated that the straws and utensils provided herein may be readily substituted for conventional straws and utensils currently in use, and in particular, disposable plastic utensils which are typically discarded after a single use. Accordingly, in addition to providing a nutritious and wholesome food product, it is contemplated that the drinking straw and utensils formed by the compositions and methods of the present invention will create substantially less refuse typically associated with meals purchased through cafeterias, fast food restaurants and the like.

In addition to the foregoing, it is contemplated that the edible straw 10 of the present invention may be configured to take the form of a whistle or other type of wind-driven musical instrument (i.e., a flute). Specifically it is contemplated that such flute-type instrument or whistle configuration can enable the straw to play musical notes or otherwise act as a noise making instrument to thus increase the appeal of the straw for use in consumption by children.

Along these lines, it is contemplated that any of a variety of well-known flute and/or whistle configurations can be incorporated into the edible drinking straw 10 of the present invention. To achieve that end, it is contemplated that various apertures will be formed upon such straw during the extrusion process or after the extrusion is cut to form the straw. To yet further enhance the attractiveness and appeal of the straw of the present invention, it is contemplated that the straw may further include ornamentation or other type of decorative indicia such as trademark logos and the like formed from edible materials such as food colorings and the like, to thus increase the visual appeal of the drinking straw. Along these lines, it is contemplated that such decorative indicia and ornamentation may take any of a variety of forms known in the art that can be readily applied to the extruded tubular straw structure as shown in FIG. 3.

As will be appreciated, additional modifications and improvements of the present invention may also be apparent to those of ordinary skill in the art. Thus, the particular combination of parts and steps described and illustrated herein is intended to represent only certain embodiments of the present invention and is not intended to serve as limitations of alternative devices and methods within the spirit and scope of the invention.

What is claimed is:

1. An edible drinking straw comprising:
a) approximately 95.0% or less by weight fruit powder;
b) approximately 5.0% or less by weight a humectant;
c) approximately 10.0% or less by weight natural flavor;
d) approximately 3.0% or less by weight natural color; and
e) wherein said fruit powder, humectant, natural flavor and natural color are blended and compacted to assume said drinking straw configuration.

2. The edible drinking straw of claim 1 wherein said fruit powder is present in an amount of at least 80.0% by weight.

3. The edible drinking straw of claim 1 wherein said humectant is present in an amount from about 0.5-5.0% by weight.

4. The edible drinking straw of claim 1 wherein said natural color is present in an amount from about 0.25-3.0% by weight.

5. The edible drinking straw of claim 1 wherein said natural flavor is present in an amount from 1.0%-10.0% by weight.

6. The edible drinking straw of claim 1 wherein said fruit powder selected from the group consisting of banana powder, apple powder, pear powder and combinations thereof.

7. The edible drinking straw of claim 1 wherein said humectant comprises glycerine.

8. The edible drinking straw of claim 1 wherein said natural color is selected from the group consisting of sugar beet extract, carrot extract, grape skin extract, and chlorophyl extract.

9. The edible drinking straw of claim 10 wherein said straw further comprises:
a) a nutritional supplement.

10. The edible drinking straw of claim 9 wherein said nutritional supplement is selected from the group consisting of a vitamin, a mineral, an herbal extract, a protein, an amino acid, a functional food and a medicinal food.

11. The edible drinking straw of claim 1 wherein:
a) said fruit powder is present in an amount of approximately 91.0% by weight;
b) said humectant is present in an amount of approximately 3.0% by weight;
c) said natural flavor is present in an amount of approximately 5.0% by weight; and
d) said natural color is present in an amount of approximately 1.0% by weight.

12. A method for forming an edible drinking straw comprising the steps:
a) providing fruit powder, a humectant, natural color, and natural flavor;
b) mixing fruit powder, humectant, natural flavor, and natural color in step a) to form an admixture;
c) compacting and extruding said admixture produced in step b) to form an elongate cylindrical tubular sleeve;
d) cutting said elongate tubular sleeve to have a select length and defining first and second opposed ends;
e) applying an edible water repellant coating upon said tubular sleeve cut in step d); and
f) packaging said coated tubular sleeve produced in step e).

13. The method of claim 12 wherein in step a), said fruit powder is selected from the group consisting of banana powder, apple powder, and pear powder.

14. The method of claim 12 wherein in step a) such humectant is comprised of glycerine.

15. The method of claim 12 wherein in steps b), c), d) and e) are performed in an environment of 5.0% humidity or less.

16. The method of claim 12 wherein in step e), said edible water repellant coating comprises carnauba wax.

17. The method of claim 12 wherein step a) further comprises providing a nutritional supplement; and wherein step b) comprises mixing said nutritional supplement with said fruit powder, humectant, natural flavor, and natural color to form said first admixture.

18. A method for forming an eating utensil comprising the steps:
a) providing fruit powder, a humectant, natural color, and natural flavor;
b) mixing fruit powder, humectant, natural flavor, and natural color in step a) to form an admixture;
c) molding said admixture in step 6 to assume the shape of a utensil selected from the group consisting of a knife, a fork, a spoon, and a chopstick;
d) applying an edible water repellant coating upon said utensil molded in step d); and
e) packaging said utensil coated in step d).

19. The method of claim 12 wherein following step d), a respective end of said extruded tubular sleeve is flattened such that a respective end of said tubular structure assumes a generally spoon shape.

20. The edible drinking straw of claim 1 wherein said edible drinking straw further includes at least one aperture formed along the length thereof for imparting a whistle sound by a user.

21. The edible drinking straw of claim 1 wherein said edible drinking straw includes a plurality of apertures capable of being selectively covered by a user's fingers to thus enable the straw to function as a flute.

22. The edible drinking straw of claim 1 wherein said edible drinking straw further includes decorative indicia formed thereon.

23. The method of claim 12 wherein prior to or during step d), at least one aperture is formed along a tubular sleeve to thus enable the elongate tubular sleeve to function as a whistle.

24. The method of claim 12 wherein prior to or during step d), multiple apertures are formed along the length of said elongate tubular sleeve to thus enable the elongate tubular sleeve to function as a flute.
